(19) United States
(12) Patent Application Publication
(10) Pub. No.: US 2002/0057367 A1
(43) Pub. Date: May 16, 2002

(54) Broadcast data receiver

(75) Inventor: Mark R. Baldock, West Yorkshire (GB)

Correspondence Address: Mark G. Kachigian, Head, Johnson & Kachigian, 228 West 17th Place, Tulsa, OK, 74119, US

(73) Assignee: PACE MICRO TECHNOLOGY PLC.

(21) Appl. No.: 09/992,269

(22) Filed: Nov. 14, 2001

(30) Foreign Application Priority Data
Nov. 15, 2000 (GB) 0027812.7

(51) Int. Cl. H04N 3/27; H04N 5/50

(52) U.S. Cl. 348/554; 348/731

(57) ABSTRACT

The invention relates to the provision of a broadcast data receiver for use in receiving digital data providing any or any combination of video, audio or auxiliary data. The broadcast data receiver receives the data via satellite, cable and/or terrestrial transmission systems via a number of RF carriers. The broadcast data receiver includes at least two tuners which can be controlled to receive data on specific data carriers at specified frequencies in response to user selections when operating a broadcast data receiver. In some instances, at least one of the tuners may not be required to receive data at a specific frequency and, in these instances, in accordance with the invention, the tuner is utilized to scan the available frequency bandwidth for service information and to store said service information for subsequent use. The invention therefore allows the utilization of a tuner when not in primary use for a useful service.

This invention relates to a broadcast data receiver for use with a television system.

The television system for the purposes of the following description includes a broadcast data receiver (BDR) for receiving digital data in the form of data streams from one or more broadcasters via satellite, terrestrial or cable and generating audio, visual and/or auxiliary data therefrom. Data streams transmitted at different frequencies from the broadcaster(s) correspond to different services such as different television channels. A display screen is provided for display of the visual data and speakers are typically provided for sounding of the audio data.

An example of a service is a television channel and it will be understood by persons skilled in the art that although the following description refers to channel information, this can include two channels encoded and transported on a single channel or carrier, thus requiring only a single tuner. Alternatively, channels can be encoded on a number of different carriers, thus requiring a timer to be tuned to different RF carriers to receive different channels, tuners and/or the like.

Some BDRs are provided with multiple tuner/front ends, which allow the BDR to function using more than one data stream at any particular time. For example, the multiple tuners can allow a user to watch a particular channel which can be referred to as the primary function whilst receiving and storing data for a different channel using the BDR, which can be referred to as the secondary function.

One conventional method by which BDRs can generate a list of available channels is by “scanning” their tuner frequency bands. This procedure is typically actuated manually and, as such, if a user wishes to find out whether there are any new channels available via the BDR, the user has to periodically rescan the tuner frequency bands of the BDR to update the list. This is time consuming and is therefore undesirable. If the user does not frequently rescan the tuner frequency bands of the BDR, the user may not be aware of new channels which are available. In addition, technical support is frequently required by users for assistance on how to manually scan for new channels.

It is therefore an aim of the present invention to provide a broadcast data receiver which overcomes the abovementioned problems.

According to a first aspect of the present invention there is provided a television system, said television system including a display screen, speakers and a broadcast data receiver (BDR) for receiving digital data carried in data streams from one or more broadcaster(s) via satellite, terrestrial or cable transmission systems, said data streams being broadcast and transmitted on radio frequency (RF) carriers at different frequencies and said data corresponding to a number of different user selectable channels and/or services and said BDR selectively processing and generating audio, video and/or auxiliary information from said data streams, in response to user selections, said BDR having two or more tuners for tuning to the required data carrier frequencies to receive data relating to two or more channels or services as and when required and characterized in that when at least one of the tuners is not in use, the said at least one tuner is operated to scan through the data carrier frequency bandwidth to allow the BDR to identify and receive system service information (SI).

Preferably the service information relates to television and/or radio channel identification information comprising audio, video and/or auxiliary data.

In one embodiment the channel information obtained by the at least one tuner can relate to information for a new channel or service and/or previously identified channel or service.

In one embodiment the received service information is stored in memory means of the BDR and if a new channel or service has been identified since a previous scan, a message or symbol can be displayed visually and/or audibly to inform the user of the apparatus of the new channel or channels and/or invite the user to view the new channel(s).

Preferably if the at least one tuner is scanning for available channel information and is then required for use on a data stream, any scanning being performed by the tuner is suspended and the tuner is made available for the data stream. The scanning can be resumed when the tuner is no longer required to be in use.

In a further aspect of the invention there is provided a broadcast data receiver for receiving data comprising video, audio and/or auxiliary data, said BDR incorporating first and second tuners, each tuner controlled to tune to a specified radio frequency to allow the BDR to receive a designated data carrier, said data carrier frequencies selected and controlled by the BDR in response to a user selection and characterized in that when said first or second tuners are not in use to tune to a specific frequency for a particular data carrier, said tuner is controlled to scan through the data carrier frequency bandwidth to identify and retrieve service information (SI).

In one embodiment, when a tuner is available, the scanning is performed continuously for as long as the tuner is available. Alternatively, the scanning is preformed at spaced time intervals.

An advantage of the present invention is that tuners which would normally have no working function when not required to tune to a specific data carrier frequency can be used to scan for service information. This removes the requirement for the user to remember to manually activate the BDR to scan the tuner frequency bandwidths to search for new channel information and update previously searched channel information. This in turn results in the user becoming aware of channels that they may not have previously been informed about at all or would only have been informed about when the user next manually programmed the BDR to scan for new channels. In addition, the channel information can be used to update network information tables and delete any discontinued channels.

A specific embodiment of the present invention will now be described with reference to the following drawings wherein:—

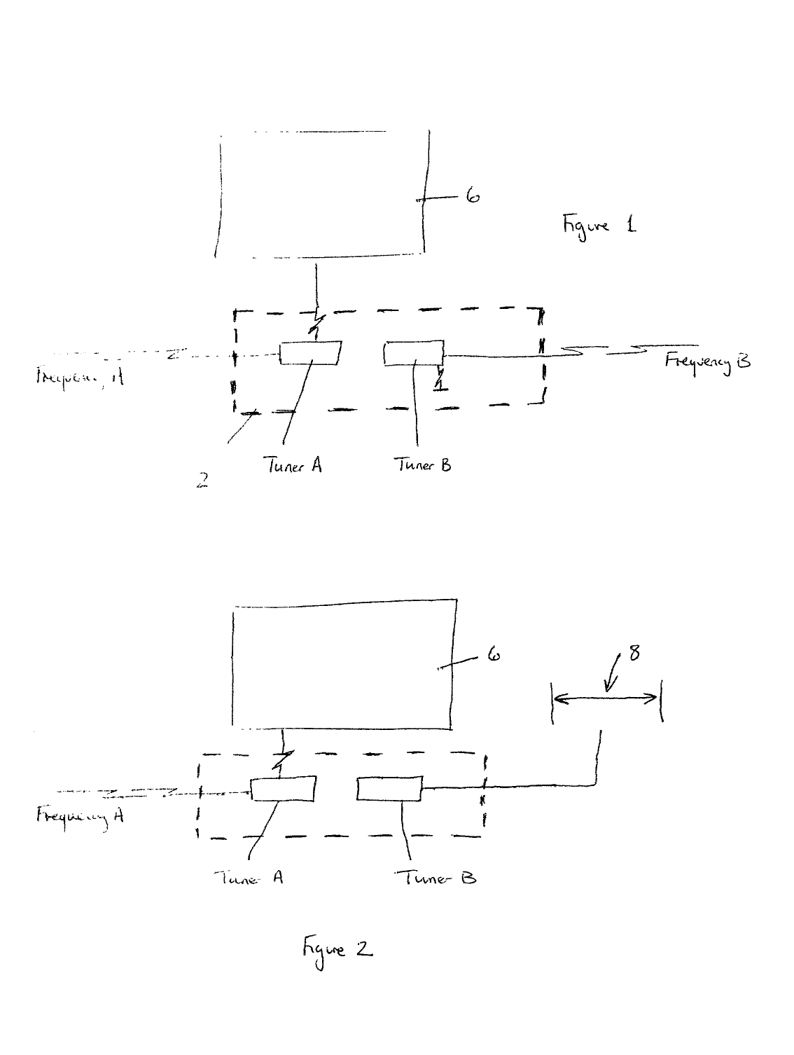

FIG.1 illustrates two BDR tuners in operation to receive specific data carriers; and

FIG. 2 illustrates the BDR tuners operating in accordance with the invention.

Many broadcast data receivers are now provided with multiple tuners to allow the generation of more than one television channel by the BDR at any particular time. This allows a user, for example, to watch one channel whilst using the BDR to record a programme from a different channel, for subsequent viewing.

In accordance with the present invention, the multiple tuners are provided with dual functionality; a primary function for tuning to, locating and locking onto an incoming data stream at a particular data carrier frequency from a number of bandwidths, a secondary function, such as receiving data from another service for recording of the same which is implemented when the tuner is not being used for the primary function, and a further function which comprises background scanning of the frequency bandwidth for channel information, but this further function requires user selection before it is conventionally performed.

In the following description, the tuners are referred to as being idle when they are not being used for either the primary or secondary functions. For example, the user may be watching a channel generate from data received by a first tuner but not using the BDR to record from a different channel and thus the second tuner is idle. Alternatively, the BDR may be performing several operations but all of which are on a single data stream from a single source (i.e., using a single tuner) and thus the second tuner is idle.

FIG. 1 illustrates the BDR 2 in use with both tuners in use. Tuner A is tuned to frequency A to receive data for a programme for viewing on display screen 6. Tuner B is tuned to frequency B to receive data for storage in memory means (not shown) in the BDR 2. In this case tuners A and B are occupied.

The status of the tuner is monitored by low-level drive software of the BDR and the criteria for determining when a tuner is idle is when the software controlling the tuner has relinquished the resources of the tuner voluntarily and has not reserved the tuner for use.

In accordance with the invention as shown in FIG. 2, in this example, tuner B is identified as being idle, the tuner B is then controlled by the BDR to scan all the available tuner frequency bandwidths 8 for service information (SI) which can relate to services or television or radio channel information. Any information identified can be stored in memory means of the BDR, such that when the scan for service information is performed, the microprocessor of the BDR can determine whether any new information has been identified. The service information obtained can include the bandwidth frequency of a new channel and/or the like, so that the channel or service can be subsequently identified.

It is noted that a pre-determined period of time can be allowed to lapse following determination that a tuner is idle, before the inventive function of the tuner is initiated. This allows time for the primary or secondary functions of the tuner to be requested again, for example, as may be the case if a person is channel hopping to and from different channels. The pre-determined time period can typically defined by the broadcaster or manufacturer of the BDR.

If during the scan for information, information relating to a new channel is identified, a message or symbol 10 can be displayed on the display screen 6 and/or operated audibly by the BDR 2 to inform the user of this information. A message can also be displayed inviting the user to view the new channel or bookmark the new channel for future viewing.

New service information is identified over old service information using in-stream data tables in the incoming data streams, and said data derived from these tables compared with data held in the BDR memory from previous searches. If certain channels or services are no longer available as identified from the received data, the same will no longer be offered to the user and so by use of the invention, the service to the user can be updated regularly and so be current with services available.

If during the scanning of the frequency bandwidths, the tuner is required for its primary or secondary function, the function of background scanning is suspended and the tuner is made available for the primary or secondary function. As soon as the tuner returns to an idle status, the interrupted scanning can be resumed. This ensures that the tuner will eventually scan the entire bandwidth for channel information.

The background scanning can be periodic and/or continuous. It is also noted that conventional manual background scanning facilities can be still be user initiated as and when required.

The present invention is in contrast to conventional BDRs where a user is required to manually program the BDR to scan for new channels or update previous channel information.

Thus it can be seen that the present invention provides a means for identifying and updating service information using already available equipment, thereby increasing the efficiency of the broadcast data receiver, without affecting the existing usage of the tuners.

1. A television system, including a display screen, speakers and a broadcast data receiver (BDR) for receiving digital data carried in data streams from one or more broadcaster(s) via satellite, terrestrial or cable transmission systems, said data streams being broadcast and transmitted on radio frequency (RF) carriers at different frequencies and said data corresponding to a number of different, user selectable, channels and/or services and said BDR selectively processing and generating audio, video and/or auxiliary information from said data streams in response to user selections, said BDR having two or more tuners for tuning to the required data carrier frequencies to receive data relating to two or more channels or services as and when required and characterized in that when at least one of the tuners is not in use the said at least one tuner is operated to scan through the data carrier frequency bandwidth to allow the BDR to identify and receive system service information (SI).

2. A system according to claim 1, characterized in that the service information for which the tuner is used to scan relates to television and/or radio channel identification information comprising audio, video and/or auxiliary data.

3. A system according to claim 1 characterised in that the service information relates to information relating to a new channel.

4. A system according to claim 1 characterised in that the service information relates to information for known channels or services.

5. A system according to claim 1 characterised in that the service information retrieved by the said at least one tuner is stored in memory means of the BDR.

6. A system according to claim 1 characterised in that if the service information retrieved includes information for a new channel or service which has been identified since the previous scan, a message or symbol is displayed visually and/or audibly to inform the user of the system of the new channel or service.

7. A system according to claim 1 characterised in that if the said at least one tuner is scanning for service information and is required to receive a designated data stream, in response to a user selection, the scanning is suspended and the tuner is made available for the data stream.

8. A system according to claim 7 characterised in that the scanning is resumed when the tuner is no longer required to receive said data stream, and there are no other pending tuning requirements.

9. A broadcast data receiver (BDR) for receiving data comprising video, audio and/or auxiliary data, said BDR incorporating first and second tuners, each tuner controlled to tune to a specified radio frequency to allow the BDR to receive a designated data carrier, said data carrier frequencies selected and controlled by the BDR in response to a user selection, and characterized in that when said first or second tuners are not in use to tune to a specific frequency for a particular data carrier, said tuner is controlled to scan through the data carrier frequency bandwidth to identify and retrieve service information (SI).

10. A broadcast data receiver according to claim 9 characterised in that the scanning operates continuously when the tuner is available.

11. A broadcast data receiver according to claim 9 characterised in that the scanning operates at spaced time intervals.
